(19) United States
(12) Patent Application Publication
(10) Pub. No.: US 2025/0204610 A1
(43) Pub. Date: Jun. 26, 2025

(54) AEROSOL GENERATING DEVICE

(71) Applicant: KT&G CORPORATION, Daejeon (KR)

(72) Inventors: Jongsub LEE, Sungnam-si Gyeonggi-do (KR); Sangkyu PARK, Seoul (KR); Byungsung CHO, Gwangmyung-si Gyeonggi-do (KR)

(73) Assignee: KT&G CORPORATION, Daejeon (KR)

(21) Appl. No.: 18/850,292

(22) PCT Filed: Apr. 3, 2023
(86) PCT No.: PCT/KR2023/004422

§ 371 Date: Sep. 24, 2024

(30) Foreign Application Priority Data
Apr. 5, 2022 (KR) 10-2022-0042491
Aug. 11, 2022 (KR) 10-2022-0100513

(51) Int. Cl. A24F 40/60; A24F 40/10; A24F 40/44; A24F 40/485

(52) U.S. Cl. CPC A24F 40/60; A24F 40/10; A24F 40/44; A24F 40/485

(57) ABSTRACT

An aerosol generating device is provided. The aerosol generating device includes: a body; a first container configured to be coupled to the body and including a wick and a heater; a second container configured to be detachably coupled to the first container and defining a chamber configured to store a liquid to be supplied to the wick; and a light source installed at the body and configured to provide light toward the chamber, wherein the second container includes an inclined wall defining an obliquely angled portion of the chamber and configured to allow transmission of light therethrough from the light source into the chamber.

### TECHNICAL FIELD

The present disclosure relates to an aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to allow components with different purposes and replacement periods to be replaced independently of each other.

It is yet another objective of the present disclosure to reduce the replacement cost of a component.

It is yet another objective of the present disclosure to improve the lifespan of a component.

It is yet another objective of the present disclosure to prevent leakage of liquid.

It is yet another objective of the present disclosure to prevent leakage of flowing gas and to increase the flow efficiency of gas.

It is yet another objective of the present disclosure to provide an improved flow path or channel to thereby reduce an aerosol generating device in size.

It is yet another objective of the present disclosure to provide an aerosol generating device that can allow the remaining amount of liquid to be easily checked with the naked eye.

It is yet another objective of the present disclosure to improve space efficiency to thereby provide an aerosol generating device with a compact size relative to its liquid storage capacity.

It is yet another objective of the present disclosure to an aerosol generating device capable of sensing a liquid storage component replaced individually.

It is yet another objective of the present disclosure to provide an aerosol generating device capable of sensing a component without requiring a separate electrical connection.

### Solution to Problem

According to one aspect of the subject matter described in this application, an aerosol generating device includes: a body; a first container configured to be coupled to the body and including a wick and a heater; a second container configured to be detachably coupled to the first container; and defining a chamber configured to store a liquid to be supplied to the wick; and a light source installed at the body and configured to provide light toward the chamber, wherein the second container includes an inclined wall defining an obliquely angled portion of the chamber and configured to allow transmission of light therethrough from the light source into the chamber.

### Advantageous Effects of Invention

According to at least one of the embodiments of the present disclosure, components with different purposes and replacement periods may be replaced independently of each other.

According to at least one of the embodiments of the present disclosure, the replacement cost of a component may be reduced.

According to at least one of the embodiments of the present disclosure, the lifespan of a component may be improved or extended.

According to at least one of the embodiments of the present disclosure, leakage of liquid may be prevented.

According to at least one of the embodiments of the present disclosure, leakage of flowing gas may be prevented, and the flow efficiency of gas may be increased.

According to at least one of the embodiments of the present disclosure, an improved flow path or channel may be provided to thereby reduce an aerosol generating device in size.

According to at least one of the embodiments of the present disclosure, an aerosol generating device that allows the remaining amount of liquid to be easily checked with the naked eye may be provided.

According to at least one of the embodiments of the present disclosure, space efficiency may be improved to thereby provide an aerosol generating device with a compact size relative to its liquid storage capacity.

According to at least one of the embodiments of the present disclosure, an aerosol generating device capable of sensing a liquid storage component that is replaced individually may be provided.

According to at least one of the embodiments of the present disclosure, a component may be sensed without requiring a separate electrical connection.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 28 illustrate examples of an aerosol generating device according to embodiments of the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

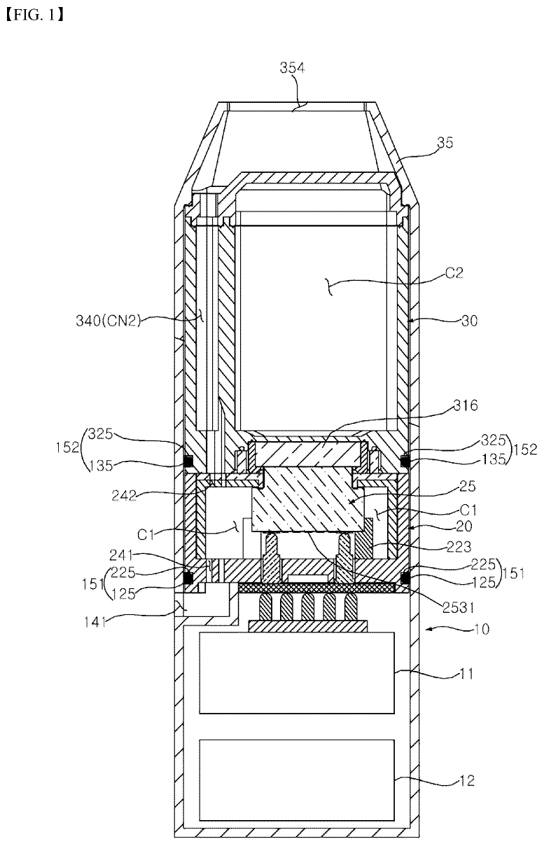

Referring to FIG. 1, an aerosol generating device may include a body 10 and a cartridge (20, 30). The cartridge (20, 30) may include a first container 20 and a second container 30. The cartridge (20, 30) may be coupled to the body 10.

The body 10 may accommodate a power source 11 and a controller 12. The power source 11 may supply power required for components to operate. The power source 11 may be referred to as a battery 11. The controller 12 may control the operation of the components.

The first container 20 may include a first chamber C1 therein. The first container 20 may include a wick 25. The wick 25 may be disposed at the first chamber C1. An upper end of the wick 25 may protrude upward of the first container 20 from the first chamber C1.

The first container 20 may include a heater 2531. The heater 2531 may be disposed at the first chamber C1. The heater 2531 may heat the wick 25. The heater 2531 may be attached to the wick 25. The first container 20 may be provided therein with a terminal 223. The terminal 223 may be exposed to a lower side of the first container 20. The terminal 223 may be electrically connected to the heater 2531. The first container 20 may be referred to as a lower container 20 or a heating module 20.

The first container 20 may have a first air flow inlet 241 formed by opening the first chamber C1. The first container 20 may have a first air flow outlet 242 formed by opening the first chamber C1.

The second container 30 may include a second chamber C2 therein. The second container 30 may store liquid in the second chamber C2. The second container 20 may have an air flow discharge path (or air outflow channel) 340. Both ends 341 and 342 of the air flow discharge path 340 may be open. The air flow discharge path 340 may be partitioned from the second chamber C2. The second container 30 may be referred to as an upper container 30 or a liquid storage part 30.

A mouthpiece 35 may be coupled on top of the second container 30. The mouthpiece 35 may cover an upper portion of the second container 30. The mouthpiece 35 may have a second air flow outlet 354 therein. The second air flow outlet 354 may communicate with a second end 342 of the air flow discharge path 340. The mouthpiece 35 may be tilted through an axis to thereby open and close the air flow discharge path 340.

The first container 20 may be coupled to the body 10. The first container 20 may be inserted into the body 10. When the first container 20 is coupled to the body 10, the heater 2531 may be electrically connected to the power source 11 through the terminal 223. The heater 2531 may generate heat using power supplied from the power source 11. The heater 2531 may be a resistive heater.

The second container 30 may be coupled on top of the first container 20. The coupling of the second container 30 to the first container 20 may include that the second container 30 is directly coupled to the first container 20 and that the second container 30 is indirectly coupled to the first container 20 by being coupled to the body 10.

When the second container 30 is coupled to the first container 20, the second container 30 may supply the stored liquid to the wick 25. The wick 25 may absorb the liquid supplied from the second container 30. The heater 2531 may heat the wick 25 impregnated with the liquid to thereby generate an aerosol in the first chamber C1.

One side of the body 10 may be open to define a second air flow inlet 141. When the first container 20 is coupled to the body 10, the first air flow inlet 241 and the second air flow inlet 141 may communicate with each other. When the second container 30 is coupled to the first container 20, a first end 341 of the air flow discharge path 340 and the first air flow outlet 242 may communicate with each other. Accordingly, a flow path or channel through which air flows may be formed. A user may inhale air while holding the mouthpiece 35 in his or her mouth. When the user inhales the air, air at the outside may sequentially pass through the second air flow inlet 141, the first air flow inlet 241, the first chamber C1, the first air flow outlet 242, the air flow discharge path 340, and the second air flow outlet 354 to be delivered to the user. The air may flow along with the aerosol generated in the first chamber C1.

Accordingly, the first container 20 and the second container 30 may be replaced independently of each other. For example, a consumption period of liquid stored in the second container 30 and a proper replacement period of the first container 20 may be different from each other, and only the second container 30 or the first container 20 may be individually replaced by the user. For example, a consumption period of liquid stored in the second container 30 may be shorter than a proper replacement period of the first container 20, and accordingly, the first container 20 may be replaced only once when the second container 30 is replaced several times. As a result, the first container 20 may be used longer to thereby reduce the replacement cost of the cartridge.

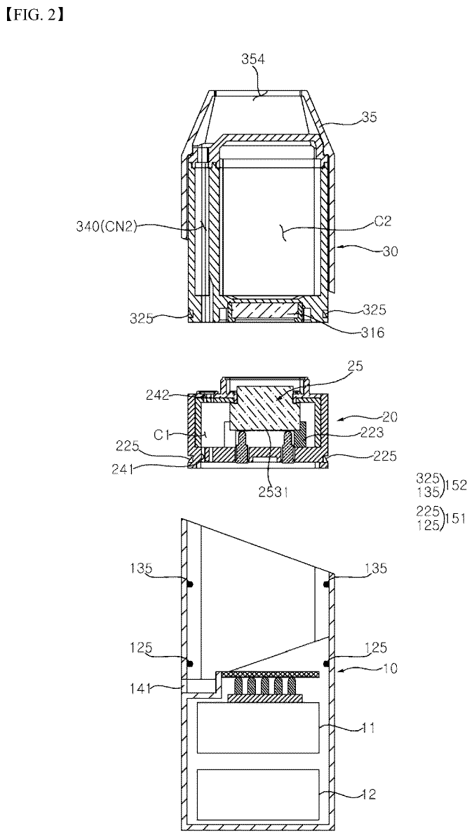

Referring to FIG. 2, the first container 20 may be detachably coupled to the body 10. A first coupler 151 may allow the first container 20 and the body 10 to be detachably coupled to each other. For example, the first coupler 151 may include a hook recess 225 and a hook 125 detachably fastened to the hook recess 225. The hook 125 may be made of a material such as rubber or silicone to seal between the body 10 in the vicinity of the second air flow inlet 141 and the first container 20. As another example, the first coupler 151 may use a magnetic force to allow the first container 20 and the body 10 to be coupled to each other.

The second container 30 may be detachably coupled to the first container 20. The second container 30 may be coupled on top of the first container 20. The second container 30 may be coupled to the body 10 so as to be indirectly coupled to the first container 20. A second coupler 152 may allow the second container 30 and the body 10 to be detachably coupled to each other. For example, the second coupler 152 may include a hook recess 325 and a hook 135 detachably fastened to the hook recess 325. As another example, the second coupler 152 may use a magnetic force to allow the second container 30 and the body 10 to be coupled to each other.

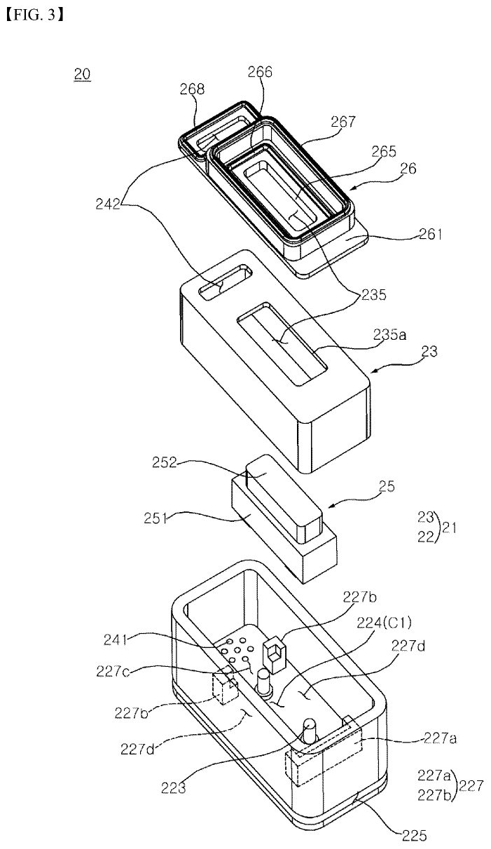

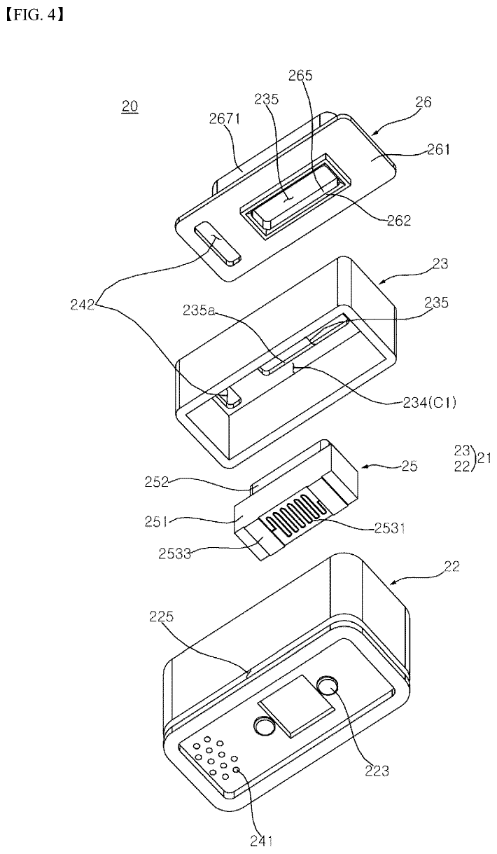

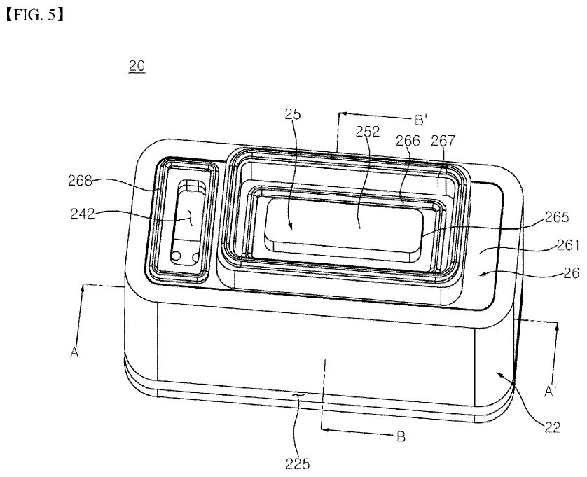

Referring to FIGS. 3 to 5, the first container 20 may include a case 21, the wick 25, and the heater 2531. The case 21 may include a first case 22 and a second case 23.

The second case 23 may be coupled on top of the first case 22. The first case 22 may be open at top, and may have a space 224 defining the first chamber C1. The second case 23 may be open at bottom, and may include a space 234 defining the first chamber C1. The first case 22 and the second case 23 may be coupled together up and down to define the first chamber C1 therein.

The terminal 223 may be fixed to a bottom of the first case 22 to be exposed to a lower side of the first case 22. The terminal 223 may protrude upward from the first case 22 toward the first chamber C1. The terminal 223 may be provided in pair, and the pair of terminals 223 may be horizontally spaced apart from each other.

The first air flow inlet 241 may be formed at the bottom of the first case 22. The first air flow inlet 241 may be provided in plurality in the form of perforated holes. The first air flow inlet 241 may be spaced apart from the terminal 223 in a horizontal direction. Alternatively, the first air flow inlet 241 may be formed by opening a lateral wall of the first case 22 and/or a lateral wall of the second case 23.

The case 21 may be provided with one component of the first coupler 151 (see FIGS. 1 and 2). For example, a lower periphery of the first case 22 may be recessed to define the hook recess 225. As another example, the lower periphery of the first case 22 may protrude to define the hook 125. As another example, the first case 21 may include a magnet or a ferromagnetic material.

The first air flow outlet 242 may be formed on an upper wall of the second case 23. As another example, the first air flow outlet 242 may be formed on the lateral wall of the second case 23. The first air flow outlet 242 may be formed at a position facing the first air flow inlet 241.

A liquid inlet 235 may be formed on the upper wall of the second case 23. The liquid inlet 235 may be formed on an upper side of the first chamber C1. The liquid inlet 235 may be partitioned from the second air flow outlet 242. The liquid inlet 235 may be formed on one side of the upper wall of the second case 23, and the first air flow outlet 242 may be formed on another side of the upper wall of the second case 23. The liquid inlet 235 may be formed on a side corresponding to the terminal 223 and a supporter 227, and the first air flow outlet 242 may be formed on a side corresponding to the first air flow inlet 241.

The wick 25 may include a first wick part 251 and a second wick part 252. The first wick part 251 may be disposed at the first chamber C1 between the first case 22 and the second case 23. A lower edge of the first wick part 252 may be supported by the supporter 227.

The second wick part 252 may protrude upward from the first wick part 251. The second wick part 252 may be exposed to an outside of the first chamber C1 through the liquid inlet 235. The second wick part 252 may protrude upward through the liquid inlet 235 and a first wick sealing portion 265.

The heater 2531 may be coupled to the first wick part 251. The heater 2531 may heat the first wick part 251. A first terminal 2533 provided at each of both ends of the heater 2531 may come into contact with the terminal 223, which is a second terminal, allowing the heater 2531 and the second terminal 223 to be electrically coupled to each other.

The supporter 227 may protrude upward from the bottom of the first case 22. The supporter 227 may be provided in the vicinity of the terminal 223. The supporter 227 may be provided in plurality, and the plurality of supporters 227 may be arranged in the vicinity of the terminal 223. The supporter 227 may include a first supporter 227a and a second supporter 227b. The first supporter 227a and the second supporter 227b may be disposed in regions corresponding to lower corners of the first wick part 251.

The first supporter 227a and the second supporter 227b may be spaced apart from each other. The second supporter 227b may be provided at a position adjacent to the first air flow inlet 241. The second supporter 227b may be provided between the terminal 223 and the first air flow inlet 241. The second supporter 227b may be provided in pair. The pair of second supporters 227b may be spaced apart from each other to form a first gap 227c therebetween. The first supporter 227a and the second supporter 227b may be spaced apart from each other to form a second gap 227d therebetween.

A sealer 26 may be coupled to a top of the first container 20. A sealing plate 261 of the sealer 26 may cover an upper surface of the case 21. The sealer 26 may be made of a material having elasticity. For example, the sealer 26 may be made of a rubber or silicone material.

The sealer 26 may include the first wick sealing portion 265. The first wick sealing portion 265 may be formed by opening the sealing plate 261 at a position corresponding to the liquid inlet 235. The first wick sealing portion 265 may define one inner peripheral surface of the sealing plate 261. The first wick sealing portion 265 may have a shape corresponding to a peripheral surface 235a that surrounds the liquid inlet 235. The first wick sealing portion 265 may protrude downward from the sealing plate 261 to be in close contact with an inside of the peripheral surface 235a of the liquid inlet 235. The second wick part 252 may protrude upward of the liquid inlet 235 through the first wick sealing portion 265.

The sealer 26 may include a second wick sealing portion 262. The second wick sealing portion 262 may protrude downward from a lower surface of the sealing plate 261. The second wick sealing portion 262 may be formed under the first wick sealing portion 265 or under the vicinity of the first wick sealing portion 265. The second wick sealing portion 262 may extend along a periphery of the first wick sealing portion 265.

The sealer 26 may include a sealing wall (266, 267) protruding upward from an upper surface of the sealing plate 261. The sealing wall (266, 267) may surround the vicinity of the liquid inlet 235 and the first wick sealing portion 265. The sealing wall (266, 267) may extend along the periphery of the first wick sealing portion 265 to define its periphery. The sealing wall (266, 267) may be provided in plurality. For example, the sealing wall (266, 267) may include a first sealing wall 266 adjacent to the vicinity of the first wick sealing portion 265 and a second sealing wall 267 spaced outward from the first sealing wall 266. The second sealing wall 267 may protrude further upward than the first sealing wall 266. The second sealing wall 267 may surround the first sealing wall 266.

The sealer 26 may include an air flow sealing portion 268. The air flow sealing portion 268 may surround the vicinity of the first air flow outlet 242. The air flow sealing portion 268 may protrude upward from the upper surface of the sealing plate 261. The second sealing wall 267 may protrude higher than the air flow sealing portion 268. The air flow sealing portion 268 may be provided outside the sealing wall 266, 267.

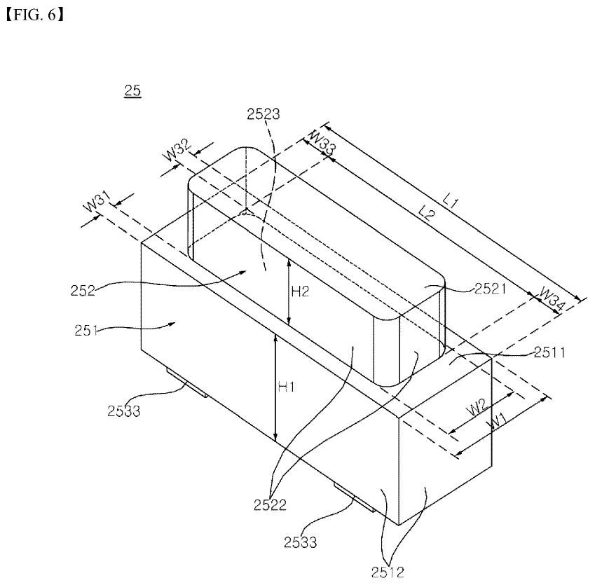

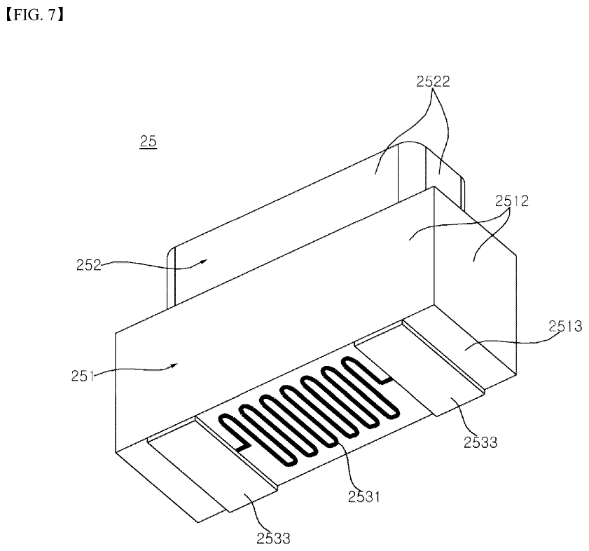

Referring to FIGS. 6 and 7, the wick 25 may be made of a porous rigid body to absorb liquid. For example, the wick 25 may be made of a porous ceramic. The wick 25 may have greater rigidity or heat resistance than a cotton wick.

Accordingly, the wick 25 may have little or no deformation, and may be implemented in various shapes. In addition, durability of the wick 25 may be improved, and a replacement period of the first container 20 having the wick 25 may be extended.

The first wick part 251 may be elongated in one horizontal direction. The first wick part 251 may have a hexahedral shape. An upper surface 2511 of the first wick part 251 may be formed horizontally. A lower surface 2513 of the first wick part 251 may be formed horizontally. A lateral surface 2512 of the first wick part 251 may be formed between a periphery of the upper surface 2511 and a periphery of the lower surface 2513 to define a periphery of the first wick part 251. The lateral surface 2512 of the first wick part 251 may be referred to as a peripheral surface 2512 of the first wick part 251.

The second wick part 252 may protrude upward from a middle of the upper surface 2511 of the first wick part 251. The second wick part 252 may be elongated in the horizontal direction. The second wick part 252 may have a hexahedral shape. An upper surface 2521 of the second wick part 252 may be formed horizontally. A lower surface 2523 of the second wick part 252 may be formed horizontally. The lower surface 2523 of the second wick part 252 may overlap the upper surface 2511 of the first wick part 251. A lateral surface 2522 of the second wick part 252 may be formed between a periphery of the upper surface 2521 and a periphery of the lower surface 2523 to define a periphery of the second wick part 252. The lateral surface 2522 of the second wick part 252 may be referred to as a peripheral surface 2522 of the second wick part 252.

The first wick part 251 may be larger in size than the second wick part 252. The periphery of the upper surface 2511 of the first wick part 251 may be greater than the periphery of the upper surface 2521 of the second wick part 252. A height H1 of the first wick part 251 may be greater than a height H2 of the second wick part 252. A length L1 of the first wick part 251 may be greater than a length L2 of the second wick part 252. A width W1 of the first wick part 251 may be greater than a width W2 of the second wick part 252.

The first wick part 251 may protrude further outward in the horizontal direction from the lower surface 2523 of the second wick part 252 by predetermined widths w31, w32, w33, and w34. The second wick part 252 may protrude from an inside of the periphery of the upper surface 2511 of the first wick part 251. The periphery of the upper surface 2511 of the first wick part 251 may protrude outward of the lower surface 2523 of the second wick part 252.

The heater 2531 may be attached to the first wick part 251. The heater 2531 may form a pattern on the lower surface 2513 of the first wick part 251. The heater 2531 may form various patterns along a longitudinal direction of the first wick part 251. Opposite ends of the heater 2531 may be adjacent to opposite ends of the first wick part 251.

A pair of first terminals 2533 may be provided at opposite end portions of the heater 2531. The first terminal 2533 may be coupled to the lower surface 2513 of the first wick part 251. The pair of first terminals 2533 may be adjacent to the opposite ends of the first wick part 251. The first terminal 2533 may protrude downward from the first wick part 251.

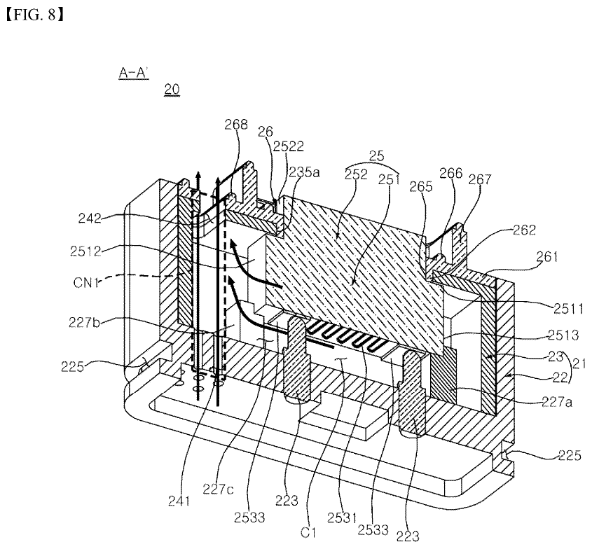

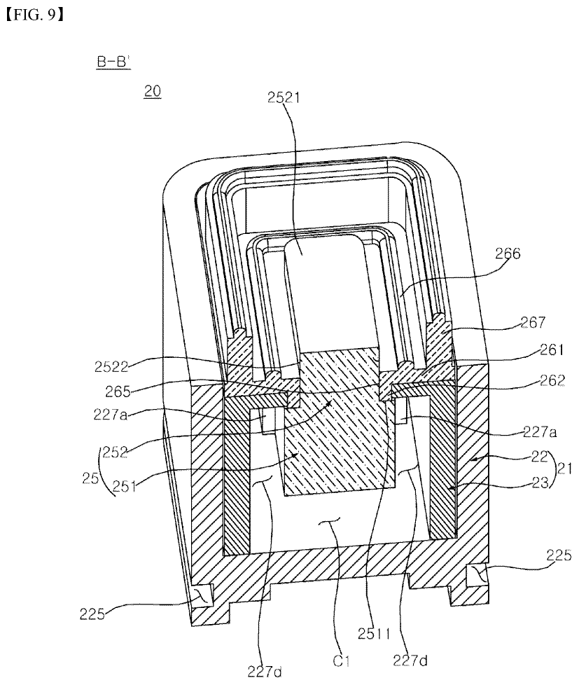

Referring to FIGS. 8 and 9, the first air flow inlet 241 may be formed on a lower side of the first chamber C1. The first air flow outlet 242 may be formed on the upper side of the first chamber C1. The first air flow inlet 241 and the first air flow outlet 242 may be arranged in parallel up and down. The wick 25 may be disposed on a right side of the first chamber C1, and the first air flow inlet 241 and the first air flow outlet 242 may be disposed on a left side of the first chamber C1. A first channel CN1 may be disposed on the left side of the first chamber C1, and may be provided with the first air flow inlet 241 and the first air flow outlet 242. Air may be introduced into the first channel CN1 through the first air flow inlet 241 and then be discharged through the first air flow outlet 242.

The first terminal 2533 may come into contact with the second terminal 223 to allow the heater 2531 and the second terminal 223 to be electrically connected to each other. The second terminal 223 may support the first terminal 2533 and the lower surface 2513 of the first wick part 251.

A lower portion of the first wick part 2511 may be supported by the supporter 227. The upper surface 2511 of the first wick part 251 may be supported by the second case 23 and/or a lower portion of the second wick sealing part 262 in the vicinity of the liquid inlet 235. A periphery of the lateral surface 2522 of the second wick part 252 may be supported by the peripheral surface 235a of the liquid inlet 235 and/or an inner surface of the first wick sealing portion 265.

Accordingly, the wick 25 may be fixed to the first container 20.

The supporter 227 may allow the first wick part 2511 to be spaced upward from a bottom of the first chamber C1. The supporter 227 may be disposed in the vicinity of the heater 2531. The supporter 227 may form the gap 227c, 227d through which the heater 2531 attached to the lower surface 2513 of the first wick part 2511 communicates with the first chamber C1. The supporter 227 may be open between the first channel CN1 and the heater 2531 to define the first gap 227c.

The supporter 227 may include the first supporter 227a and the second supporter 227b. The second supporter 227b may be disposed closer to the first air flow inlet 241 and the first air flow outlet 242 than the first supporter 227a. The first air flow inlet 241 and the first air flow outlet 242 may be adjacent to a left side of the first wick part 251. The first supporter 227a may be elongated along a right edge between the lower surface 2513 and the lateral surface 2512 of the first wick part 251. The first supporter 227a may support right corners between the lower surface 2513 and the lateral surface 2512 of the first wick part 251. The pair of second supporters 227b may support left corners of the first wick part 251, respectively.

The pair of second supporters 227b may be spaced apart from each other to form the first gap 227c between the vicinity of the heater 2531 and the first air flow inlet 241 to allow air to flow through. The first supporter 227a and the second supporter 227b may be spaced apart from each other to form the second gap 227d between the vicinity of the heater 2531 and the first air flow inlet 241 to allow air to flow through. The first gap 227c and the second gap 227d may be formed in the vicinity of the lower surface 2513 of the first wick part 251.

Accordingly, an aerosol generated by the wick 25 and its surrounding air may pass through the vicinity of the plurality of supporters 227 to smoothly flow toward the first air flow outlet 242.

The first wick sealing portion 265 may be disposed between the peripheral surface 2522 of the second wick part 252 and the peripheral surface 235a of the liquid inlet 235. An inner peripheral surface of the first wick sealing portion 265 may be in close contact with the peripheral surface 2522 of the second wick part 252. The first wick sealing portion 265 may seal between the peripheral surface 2522 of the second wick part 252 and the peripheral surface 235a of the liquid inlet 235.

The periphery of the upper surface 2511 of the first wick part 251 may be greater than a periphery of the liquid inlet 235. The periphery of the upper surface 2511 of the first wick part 251 may be located outward in the horizontal direction relative to the periphery of the liquid inlet 235. An edge portion of the first wick part 251 may absorb liquid leaking between the liquid inlet 235 and the peripheral surface 2522 of the second wick part 252.

The second wick sealing portion 262 may protrude downward from the vicinity of the liquid inlet 235 toward the upper surface 2511 of the first wick part 251. The second wick sealing portion 262 may be in close contact with the upper surface 2511 of the first wick part 251. The second wick sealing portion 262 may support the upper surface 2511 of the first wick part 251.

Accordingly, liquid supplied from the second container 30 to the wick 25 may be prevented from leaking into the first chamber C1 through a gap between the second wick part 252 and the peripheral surface 235a of the liquid inlet 235, without being absorbed into the wick 25.

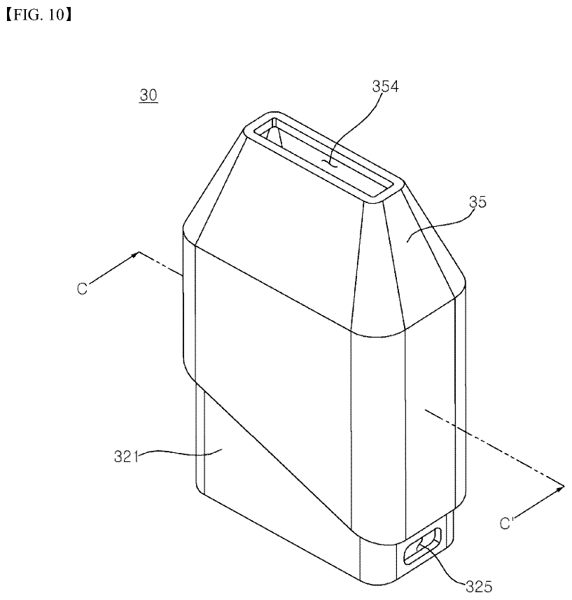

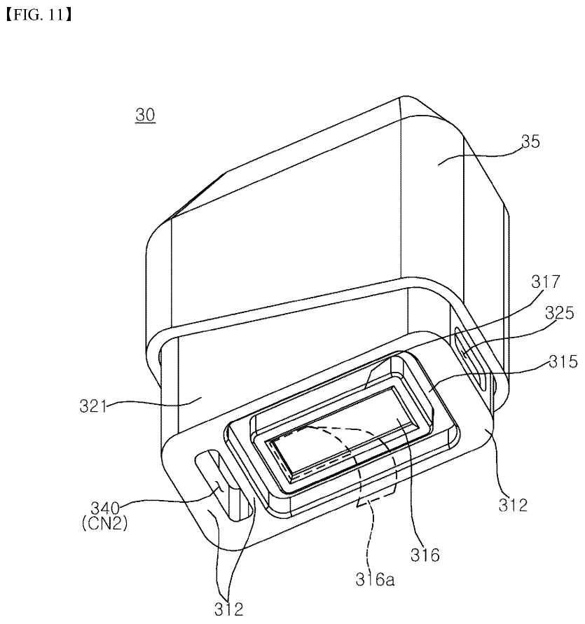

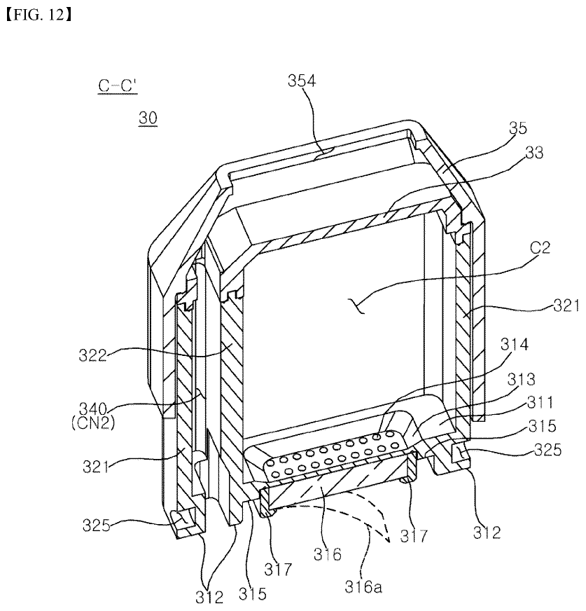

Referring to FIGS. 10 to 12, the second container 30 may include the second chamber C2 in which liquid is stored. The second chamber C2 may be defined by a lower wall 311, a lateral wall (321, 322), and an upper wall 33 of the second container 30. The lateral wall (321, 322) may extend vertically. The lateral wall (321, 322) may include an outer lateral wall 321 defining an outside (or exterior) of the second container 30 and an inner lateral wall 322 formed inside the second container 30. The inner lateral wall 322 may be formed between the second chamber C2 and the air flow discharge path 340 to partition the second chamber C2 and the air flow discharge path 340 from each other.

The second chamber C2 may be open to define a liquid outlet 314. The liquid outlet 314 may be formed at a lower portion of the second chamber C2. The liquid outlet 314 may be configured as a plurality of holes. Liquid stored in the second chamber C2 may be discharged through the liquid outlet 314.

A discharge guide 313 may be provided around the liquid outlet 314. The discharge guide 313 may be inclined downward toward the liquid outlet 314. The discharge guide 313 may be formed on the lower wall 311 of the second chamber C2. The discharge guide 313 may guide the liquid stored in the second chamber C2 to the liquid outlet 314.

An absorbent portion 316 may block or cover a bottom of the liquid outlet 314. The absorbent portion 316 may absorb liquid that has passed through the liquid outlet 314. For example, the absorbent portion 316 may be made of a felt material.

A bracket 317 may protrude downward from the second container 30 in the vicinity of the liquid outlet 314. The bracket 317 may surround a lateral periphery of the absorbent portion 316. The absorbent portion 316 may be exposed from the bracket 317 to a lower side of the second container 30. The bracket 317 may allow the absorbent portion 316 to be fixed to a lower portion of the first container 30. The bracket 317 may support a lower periphery of the absorbent portion 316 in a hook shape.

A film 316a may be detachably attached to a lower surface of the absorbent portion 316. An edge of the film 316a may be attached to a lower surface of the bracket 317. The film 316a may be made of a waterproof material. The film 316a may prevent liquid from leaking from the absorbent portion 316. A user may remove the film 316a from the absorbent portion 316 before coupling the second container 30 to the first container 20.

A lower surface 312 of the second container 30 may be recessed upward to define a recess portion 315. A recess formed by the recess portion 315 may surround the bracket 317.

The second container 30 may be provided with one component of the second coupler 152 (see FIGS. 1 and 2). For example, the outer lateral wall 321 of the second container 30 may be recessed to define the hook recess 325. As another example, the outer lateral wall 321 of the second container 30 may protrude to define the hook 135. As another example, the second container 30 may include a magnet or a ferromagnetic material.

The second container 30 may have the air flow discharge path 340. The air flow discharge path 340 may be partitioned from the second chamber C2 by the inner lateral wall 322 of the second container 30. The air flow discharge path 340 may be defined by the outer lateral wall 321 and the inner lateral wall 322 of the second container 30. Both ends of the air flow discharge path 340 may be open. One end (or first end) of the air flow discharge path 340 may be open downward. Another end (or second end) of the air flow discharge path 340 may open upward. The one end of the air flow discharge path 340 may be formed by opening the lower surface 312 of the second container 30. The another end of the air flow discharge path 340 may communicate with the second air flow outlet 354 formed at the mouthpiece 35. The air flow discharge path 340 may be referred to as a second channel CN2.

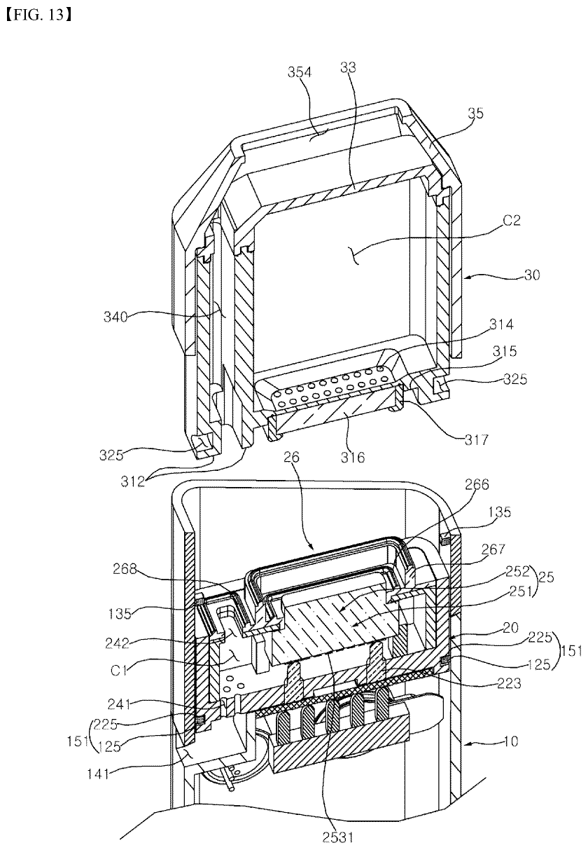

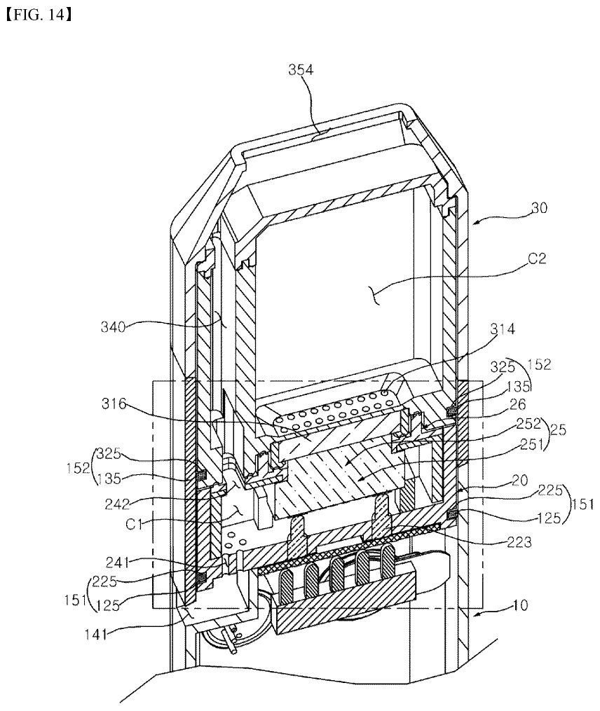

Referring to FIGS. 13 and 14, the first container 20 may be detachably coupled to the body 10. The first coupler 151 may allow the first container 20 and the body 10 to be detachably coupled to each other. The second container 30 may be detachably coupled to the first container 20. The second container 30 may be coupled to the body 10 through the second coupler 152, allowing the second container 30 to be indirectly coupled to the first container 20. The second container 30 may be coupled on top of the first container 20.

When the second container 30 is coupled to the first container 20, the second container 30 may supply liquid to the wick 25. The liquid stored in the second chamber C2 may pass through the liquid outlet 314 to be absorbed by the absorbent portion 316, and the absorbent portion 316 impregnated with the liquid may come into contact with the second wick part 252, so that the liquid is transferred to the second wick part 252. The liquid absorbed into the second wick part 252 may be distributed into the first wick part 251. The heater 3531 may heat the first wick part 251 impregnated with the liquid to generate an aerosol.

The sealer 26 may seal around the liquid inlet 235 through which the wick 25 is exposed from the first chamber C1. When the second container 30 is coupled on top of the first container 20, the sealer 26 may seal between the first container 20 and the second container 30.

The sealing wall 266, 267 may protrude toward the second container 30. The sealing wall 266, 267 may be in close contact with the second container 30. The sealing wall 266, 267 may surround the vicinity of the liquid inlet 235.

Accordingly, liquid discharged from the second container 30 may be prevented from leaking into a gap between the first container 20 and the second container 30.

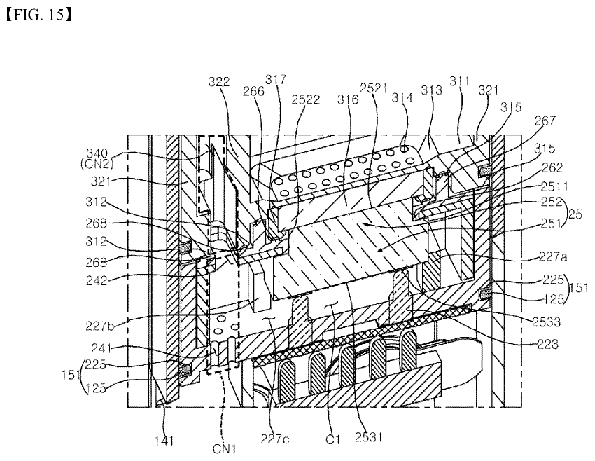

Referring to FIG. 15, the first sealing wall 266 may surround the liquid inlet 235 and the peripheral surface 2522 of the second wick part 252. The first sealing wall 266 may be in close contact with a lower portion of the second container 30. The first sealing wall 266 may be in close contact with a protruding portion formed inside the recess portion 315. For example, the first sealing wall 266 may be in close contact with the bracket 317. The bracket 317 and the first sealing wall 266 may surround the peripheral surface 2522 of the second wick part 252. Accordingly, the bracket 317 may not only fix the absorbent portion 316, but also may press the first sealing wall 266 to thereby seal around the second wick part 252 and the liquid inlet 235.

The second sealing wall 267 may protrude higher than the first sealing wall 266. The second sealing wall 267 may be disposed outside the first sealing wall 266 in the horizontal direction to surround the vicinity of the first sealing wall 266. The second sealing wall 267 may be in close contact with the lower portion of the second container 30. The second sealing wall 267 may be inserted into a recess formed by the recess portion 315 to be in close contact with the recess portion 315.

Accordingly, the first sealing wall 266 may seal around the second wick part 252 and the liquid inlet 235. In addition, even when liquid flows over to an outside of the first sealing wall 266, the liquid may be sealed by the second sealing wall 267.

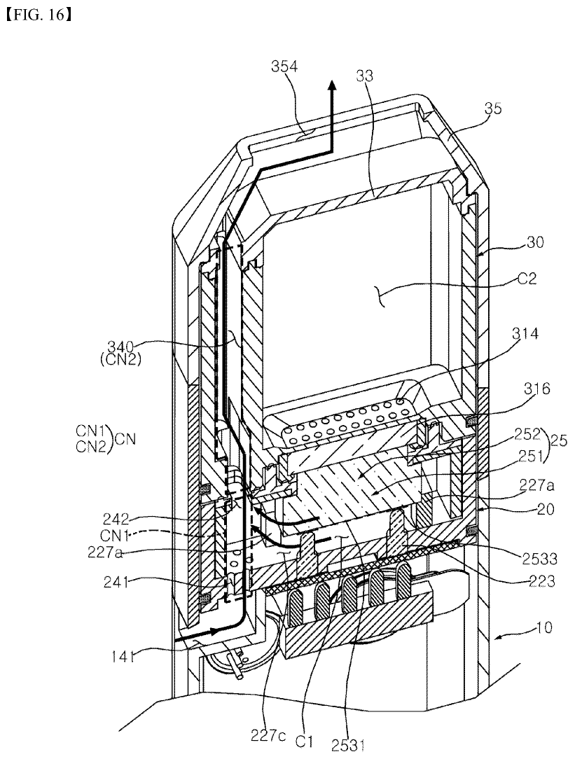

Referring to FIGS. 15 and 16, the first channel CN1 may be formed on the left side of the first chamber C1. The wick 25 and the heater 2531 may be disposed on the right side of the first chamber C1. The first channel CN1 may have the first air flow inlet 241 and the first air flow outlet 242. The first air flow inlet 241 may be formed on one end (or first end) of the first channel CN1. The first air flow outlet 242 may be formed on another end (or second end) of the first channel CN1. The first channel CN1 may be offset or deviated from the wick 25 with respect to the vertical direction. The wick 25 may be spaced between the first air flow inlet 241 and the second air flow inlet 242. Unlike the drawings, at least one of the first air flow inlet 241 and the first air flow outlet 242 may be formed at the first channel CN1 by opening a lateral wall of the first container 20.

When the first container 20 is coupled to the body 10, the second air flow inlet 141 formed by opening one side of the body 10 may communicate with the first air flow inlet 241. A gap between the body 10 and the first container 20 may be sealed in the vicinity of the second air flow inlet 141. For example, the hook 125 may seal between the body 10 and the first container 20 in the vicinity of the second air flow inlet 141.

When the second container 30 is coupled to the first container 20, the first air flow outlet 242 and a lower end of the second channel CN2 may communicate with each other. The first channel CN1 and the second channel CN2 may communicate with each other to form one channel CN. The second channel CN2 may communicate with the second air flow outlet 354.

When a user inhales air while holding the mouthpiece 35 in his or her mouth, air at the outside may sequentially pass through the second air flow inlet 141, the first channel CN1, the second channel CN2, and the second air flow outlet 354 to be delivered to the user. An aerosol may be generated in the first chamber C1 that is spaced apart from the first channel CN1. Due to a suction force and a pressure difference, air passing through the first channel CN1 may flow along with air and the aerosol of the first chamber C1. The air and the aerosol may flow into the first channel CN1 through the first gap 227c and the second gap 227d between the supporters 227.

As the air is made to flow to only one side of the first chamber C1, a size of the channel may be reduced, and a size of the aerosol generating device may be reduced or optimized. In addition, air flow resistance from the structure that supports the wick 25 may be reduced.

The air flow sealing portion 268 may be in close contact with the lower portion of the second container 30 in the vicinity of the lower end of the second channel CN2. The air flow sealing portion 268 may surround the lower end of the second channel CN2 and the vicinity of the first air flow outlet 242. The air flow sealing portion 268 may seal between the first container 20 and the second container 30 in the vicinity of the lower end of the air flow discharge path 340 and the first air flow outlet 242.

Accordingly, air passing from the first air flow outlet 242 to the air flow discharge path 340 may be prevented from leaking between the first container 20 and the second container 30, and the air flow efficiency may be improved.

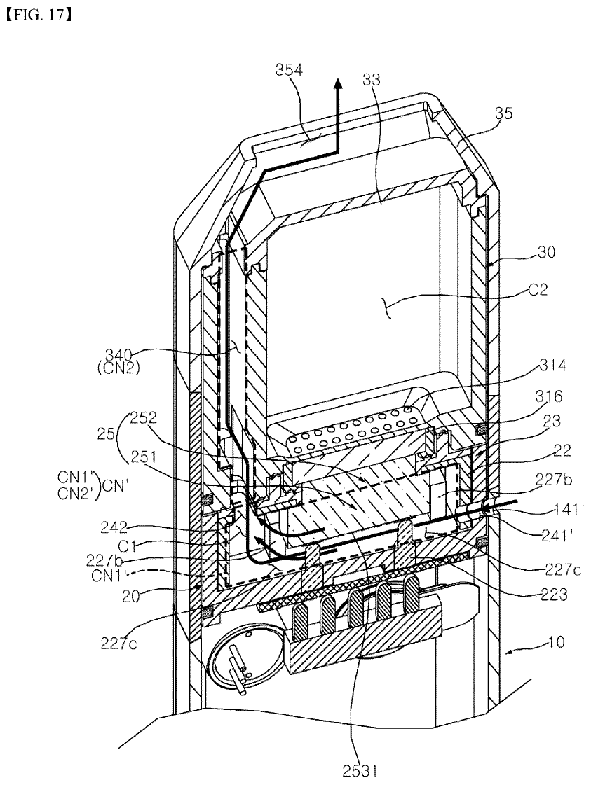

Referring to FIG. 17, a first air flow inlet 241′ and a second air flow inlet 141′ may be formed at positions different from those of the embodiment of FIG. 16. The first air flow inlet 241′ may be formed on a lateral side of a first chamber C1. The second air flow inlet 141′ may be formed at a body 10, and may communicate with the first air flow inlet 241′. The second air flow inlet 141′ may face the first air flow inlet 241′.

A first channel CN1′ may be formed in the first chamber C1, and may have the first air flow inlet 241′ and a first air flow outlet 242 at both ends thereof. A wick 25 may be disposed between the first air flow inlet 241′ and the first air flow outlet 242. The first channel CN1′ may pass through the wick 25. The first channel CN1′ may communicate with a second channel CN2 to form a flow channel CN' through which air flows.

Four second supporters 227b may support four lower vertexes of a first wick part 251, respectively. A first gap 227c may be formed in the vicinity of a lower portion of the first wick part 251. The first channel CN1′ may pass through the first gap 227c.

Air may be discharged by sequentially passing through the second air flow inlet 141′, the first channel CN1′, the second channel CN2, and a second air flow outlet 354. The air may entrain or carry an aerosol of the first chamber C1 while passing through the first channel CN1′.

Accordingly, the channel and the aerosol generating device may be reduced in size. In addition, air flow resistance from the structure that supports the wick 25 may be reduced.

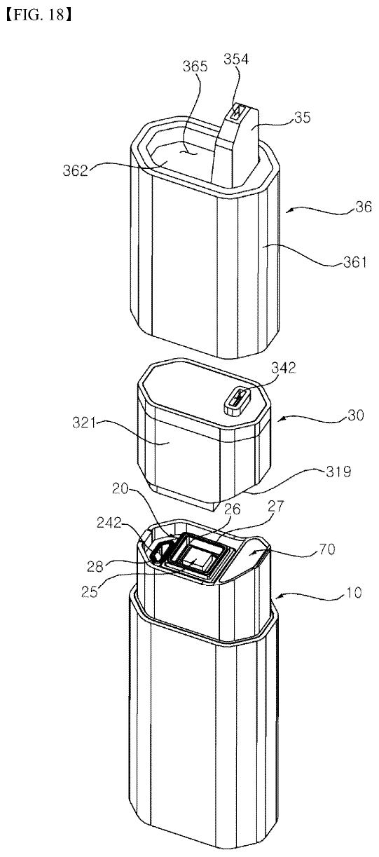

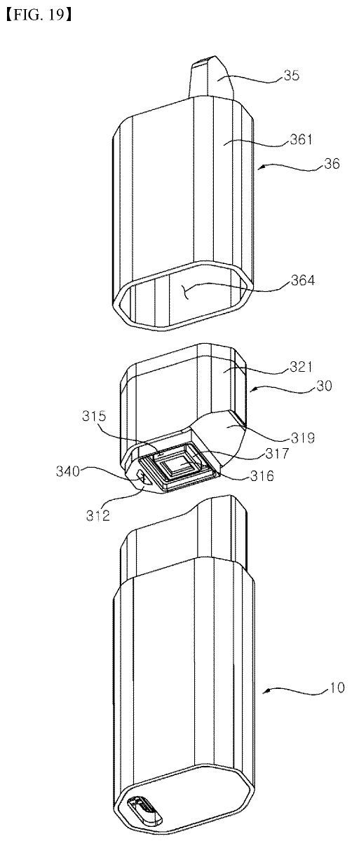

Referring to FIGS. 18 and 19, a second container 30 may be detachably coupled on top of a first container 20. The second container 30 may be coupled to a body 10, so that the second container 30 is indirectly coupled to the first container 20. As the second container 30 is coupled on top of the first container 20, the second container 30 may be exposed to an upper side of the body 10.

The aerosol generating device may further include an upper case 36. The upper case 36 may have a cavity 364 open at bottom. The upper case 36 may be detachably coupled on top of the body 10. A mouthpiece 35 may be coupled to the upper case 36. The second container 30 may be inserted into the cavity 364 of the upper case 36, and an outer wall 361 of the upper case 36 may surround and cover an outside of the second container 30. A second air flow outlet 354 of the mouthpiece 35 may communicate with a first air flow outlet 342. A portion corresponding to the second chamber C2 of the outer wall 361 of the upper case 36 may, at least partially, transmit light. The upper case 36 may have a window on the outer wall 361 thereof.

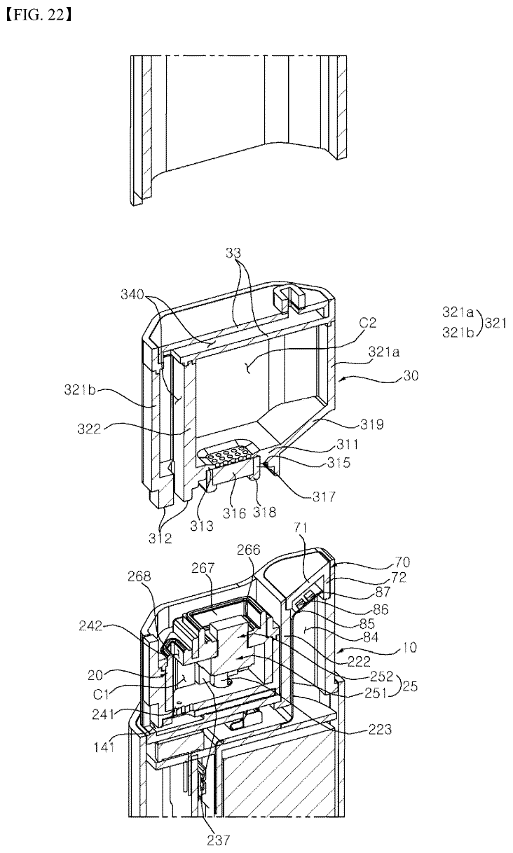

The second container 30 may have an inclined wall 319. The inclined wall 319 may be formed such that one corner (or edge) of the second container 30 is tapered obliquely. The inclined wall 319 may be formed by chamfering one corner of the second container 30. The inclined wall 319 may be provided with a second chamber C2 (see FIG. 22).

The inclined wall 319 may be disposed in the vicinity of an absorbent portion 316. The inclined wall 319 may be formed in a position opposite an air flow discharge path 340 with respect to the absorbent portion 316. For example, the air flow discharge path 340 may be formed on a left side of the absorbent portion 316, and the inclined wall 319 may be formed on a right side of the absorbent portion 316.

A cover 70 may be disposed in the vicinity of the first container 20. The cover 70 may be spaced apart from the first container 20 in a horizontal direction. For example, the first container 20 may be disposed on the left and the cover 70 may be disposed on the right. The cover 70 may be disposed opposite a first air flow outlet 242 with respect to a wick 25. For example, the first air flow outlet 242 may be disposed on a left side of the wick 25, and the cover 70 may be disposed on a right side of the wick 25. The cover 70 may be disposed upward relative to the first container 20.

The cover 70 may be disposed at a position corresponding to the inclined wall 319. The cover 70 may be inclined at a slope (or inclination) corresponding to the inclined wall 319. The cover 70 may be disposed under the inclined wall 319. The inclined wall 319 may cover the cover 70. When the second container 30 is coupled to the first container 20, the inclined wall 319 may slide on the cover 70.

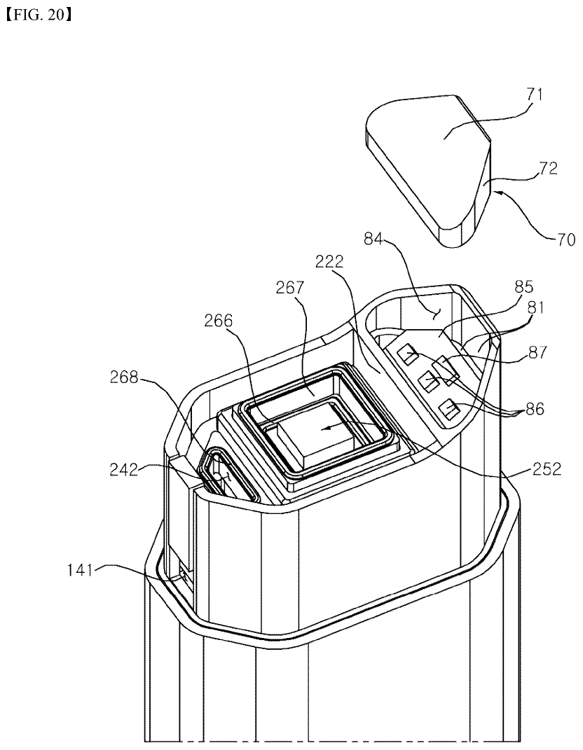

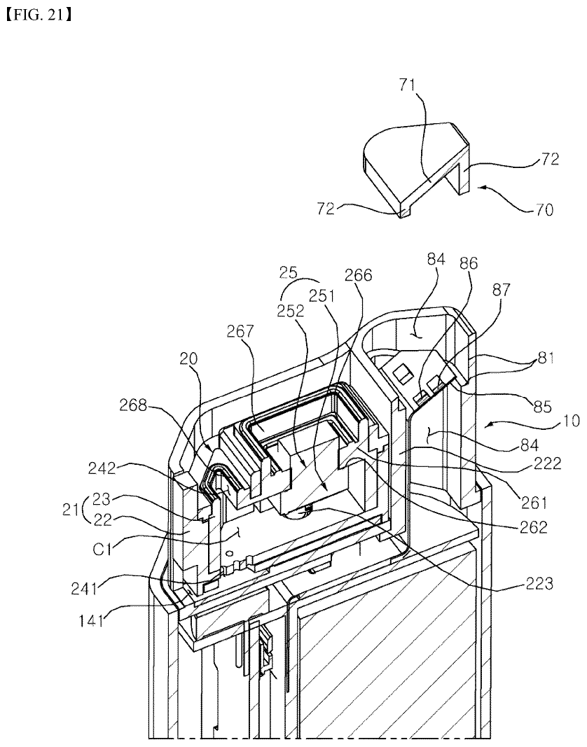

Referring to FIGS. 20 and 21, an accommodation space 84 may be partitioned from a first chamber C1 by a partition wall 222. The partition wall 222 may extend vertically between the first chamber C1 and the accommodation space 84. The first chamber C1 may be formed on a left side of the partition wall 222, and the accommodation space 84 may be formed on a right side of the partition wall 222. The accommodation space 84 and the partition wall 222 may extend further upward than the first container 20. The accommodation space 84 may open at top.

A light source 86 may be disposed in the accommodation space 84. The light source 86 may face the opening of the accommodation space 84. The light source 86 may emit light in a direction toward which it is directed. For example, the light source 86 may be a light-emitting diode (LED). The light source 86 may be installed on a substrate 85. The substrate 85 may be directly or indirectly connected to a power source 11 and/or a controller 12. The substrate 85 may be inclined obliquely. The light source 86, together with the substrate 85, may be inclined obliquely. The light source 86 may be inclined in a direction in which the inclined wall 319 forms a slope. The light source 86 may emit light toward the second container 30.

A sensor 87 may be disposed in the vicinity of the light source 85. The sensor 87 may be installed on the substrate 85. The sensor 87 may be adjacent to the opening of the accommodation space 84. The sensor 87 may be a proximity sensor. The sensor 87 may sense an electromagnetic change in the surroundings.

The cover 70 may cover the top opening of the accommodation space 84. The cover 70 may cover the light source 86. The cover 70 may be made of a light-transmitting or transparent material. The cover 70 may transmit light emitted from the light source 86. The cover 70 may cover the sensor 86.

The cover 70 may include a first cover part 71 inclined obliquely and a second cover part 72 extending downward from a periphery of the first cover part 71. The first cover part 71 may be inclined in a direction in which the light source 86 is inclined. The second cover part 72 may define a periphery of the cover 70.

The second cover part 72 may be supported by a cover supporter 81 formed at an upper edge of the accommodation space 84. The cover supporter 81 may include a bottom support portion 811 protruding inward from an edge of the accommodation space 84. The bottom support portion 811 may support a lower end of the second cover part 72. The cover supporter 81 may include a lateral support portion 812 that protrudes upward from the bottom support portion 811 and surrounds an upper portion of the accommodation space 84. The lateral support portion 812 may support a lateral side of the second cover part 72.

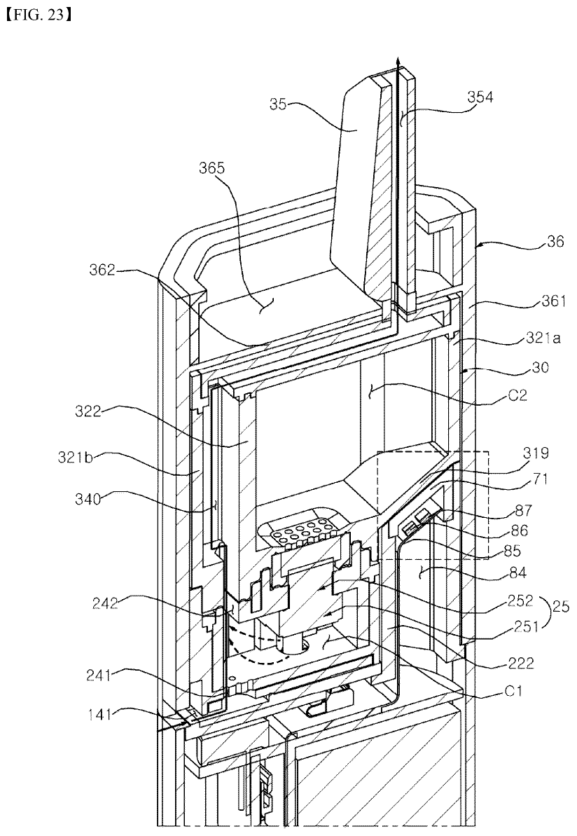

Referring to FIGS. 22 and 23, a lower wall 311 and a lateral wall (321, 322) that define the second chamber C2 may transmit light. An upper wall 33 of the second chamber C2 may transmit light. A portion covering the second chamber C2 of the outer wall 361 of the upper case 36 may, at least partially, transmit light.

The inclined wall 319 may be formed between the lower wall 311 and an outer lateral wall 321a of the second chamber C2. The inclined wall 319 may be inclined downward from the outer lateral wall 321a toward the lower wall 311. The inclined wall 319 may cover the second chamber C2.

The second container 30 may be detachably coupled to the first container 20. The cover 70 may be disposed under the inclined wall 319. The cover 70 may be disposed between the inclined wall 319 and the light source 86. The cover 70 and the inclined wall 319 may have a corresponding slope. The cover 70 may face the inclined wall 319. The cover 70 may come into contact with the inclined wall 319.

The light source 86 may be adjacent to the cover 70 and the inclined wall 319. The light source 86 may face the cover 70 and the inclined wall 319. The light source 86 may be inclined in a direction in which the inclined wall 319 is inclined. Light emitted from the light source 86 may pass through the cover 70 and the inclined wall 319 and then be provided to the second chamber C2.

Accordingly, the capacity of liquid stored in the second chamber C2 may be easily checked with the naked eye. Also, the capacity of liquid stored in the second chamber C2 may be easily seen even in a dark environment.

In addition, a region where light is provided may be increased in the second chamber C2, and a dark side or region where no light is provided may be reduced. Further, the liquid storage capacity or structural space efficiency of the second chamber C2 may be improved compared to the case where the light source 86 is disposed to face the second chamber C2 at a lateral side of the second chamber C2.

When the second container 30 approaches the first container 20, the sensor 87 may sense an electromagnetic change. The sensor 87 may transmit a signal to the controller 12 upon detection of the electromagnetic change. Based on the signal received from the sensor 87, the controller 12 may determine that the second container 30 is nearby or is coupled to the first container 20.

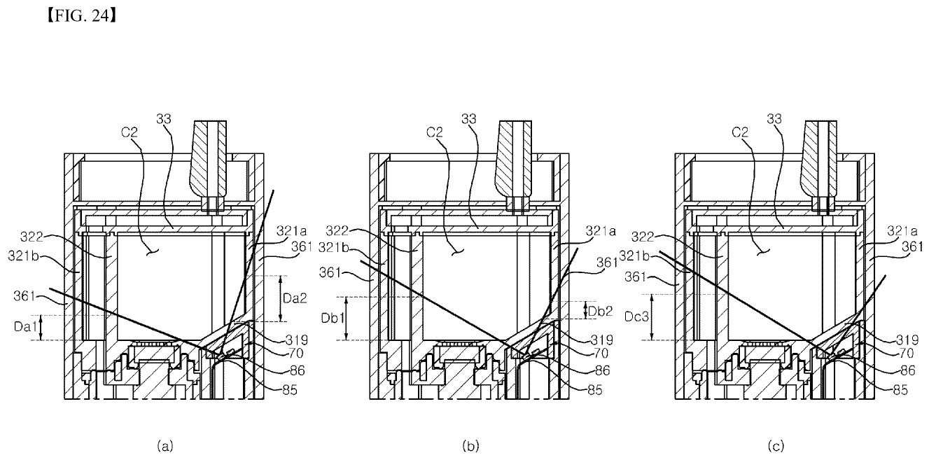

Referring to FIG. 24, an emission range according to the inclination angle of the light source 86 with respect to the horizontal direction is illustrated. The light source 86 may be inclined toward the second chamber C2 at a predetermined angle with respect to the horizontal direction.

For example, the light source 86 may be an LED with a light diffusion range of about 120°. (a), (b), and (c) of FIG. 24 respectively illustrate examples of the light source 86 with a slope of 40°, 30°, and 20° with respect to the horizontal direction. In the case of (a), (b), and (c), a dark region (Da1, Da2, Db1, Db2, Dc1) may be formed on one side and another (or opposite) side of the second chamber C2. The dark region Da1, Da2, Db1, Db2, Dc1 may vary in size according to a placement angle of the light source 86. The size of a dark region may be reduced when the light source 86 is disposed in an inclined manner, compared to the case where the light source 86 is disposed in a perpendicular manner.

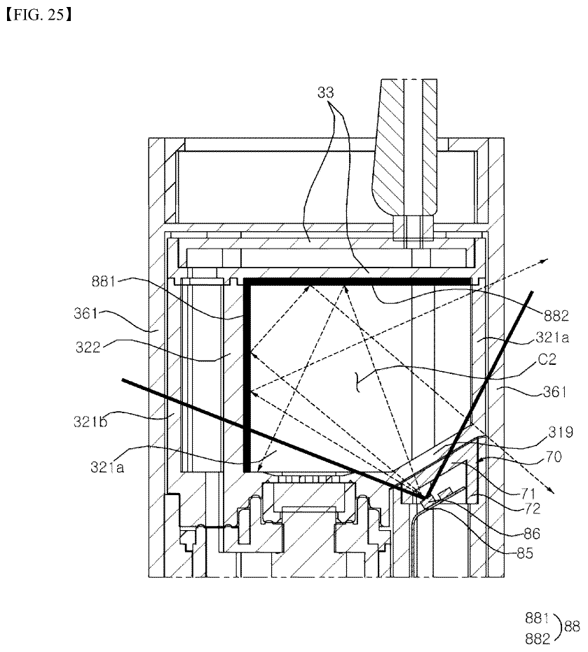

Referring to FIG. 25, the light source 86 may face a reflector 88, and may provide light to the reflector 88. The reflector 88 may reflect light, transmitted into the second chamber C2 from the light source 86, back to the second chamber C2. Light introduced into the reflector 88 may be reflected toward a dark region.

The reflector 88 may be attached to a wall of the second chamber C2 so as to face the second chamber C2. The inclined wall 319 may face the reflector 88. The reflector 88 may be attached to a wall of the second chamber C2 that is adjacent to a corner opposite the inclined wall 319 with respect to the second chamber C2. For example, the inclined wall 319 may be formed such that a corner between the lower wall 311 and the outer lateral wall 321a of the second chamber C2 is tapered, and the reflector 88 may be attached to at least part of one of the upper wall 33 of the second chamber C2 and an inner lateral wall 322 of the second chamber C2.

A first reflector 881 may be disposed on the inner lateral wall 322 of the second chamber C2. The first reflector 881 may reflect light received from the light source 86 to the outer lateral wall 321a of the second chamber C2 or a second reflector 882. The second reflector 882 may be disposed on the upper wall 33 of the second chamber C2. The second reflector 882 may reflect light received from the light source 86 to the outer lateral wall 321a of the second chamber C2 or the first reflector 881.

The first reflector 881 may reflect light received and reflected by the second reflector 882 to the outer lateral wall 321a of the second chamber C2. The second reflector 882 may reflect light received and reflected by the first reflector 881 to the outer lateral wall 321a of the second chamber C2.

As the reflector 88 is provided, the dark region may be reduced in size or be removed.

As another example, the light source 86 may be disposed under the second chamber C2, and may face the second chamber C2 vertically upward. The inclined portion 319 may be excluded. The reflector 88 may reflect light received from the light source 86 to the outer lateral wall 321a of the second chamber C2, allowing the dark region to be reduced in size or be removed.

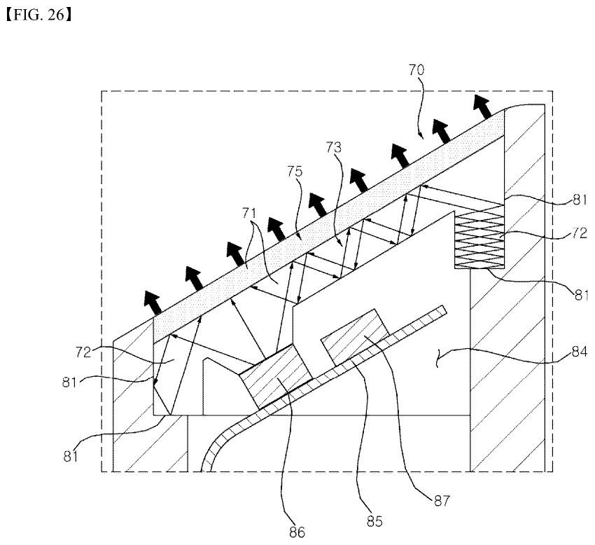

Referring to FIGS. 26 to 28, the cover 70 may include a light guide plate 73. The light guide plate 73 may be inclined at a slope corresponding to the inclined wall 319. The light guide plate 73 may face the inclined wall 319. The light guide plate 73 may define the first cover part 71 and the second cover part 72. The first cover part 71 may have a shape and size corresponding to the inclined wall 319. The light guide plate 73 may cover the light source 86. The light guide plate 73 may receive light from the light source 86, and then distribute the light throughout the light guide plate 73. The light guide plate 73 may allow light incident from the light source 86 to spread widely.

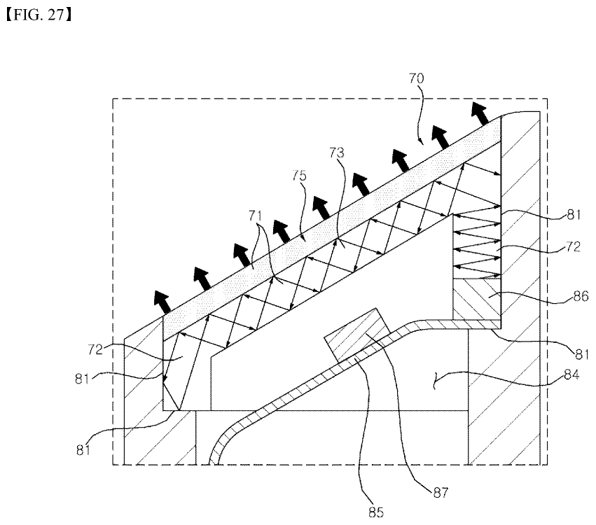

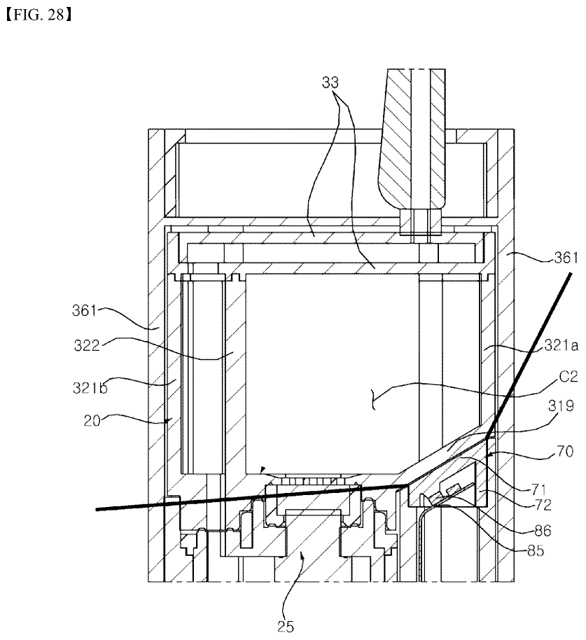

The light source 86 may be in contact with or adjacent to one side of the light guide plate 73. In one example, referring to FIG. 27, the light source 86 may be adjacent to or in contact with the first cover part 71 of the light guide plate 73, allowing the light source 86 to provide light to the first cover part 71. In another example, referring to FIG. 28, the light source 86 may be adjacent to or in contact with the second cover part 72 of the light guide plate 73, allowing the light source 86 to provide light to the second cover part 71. Light introduced into the light guide plate 73 from the light source 86 may by totally reflected in the light guide plate 73, so that the light is distributed throughout the light guide plate 73.

The cover 70 may include a diffuser 75. The diffuser 75 may be referred to as a diffusion plate 75 or a diffusion sheet 75. The diffuser 75 may cover the light source 86. The diffuser 75 may diffuse light emitted from the light source 86 into the second chamber C2. The diffuser 75 may prevent the light emitted from the light source 86 from being partially concentrated, allowing the light to be more uniformly or evenly distributed.

The diffuser 75 may be disposed on the light guide plate 73. One surface of the diffuser 75 may be in close contact with one surface of the light guide plate 73 to cover the one surface of the light guide plate 73. The diffuser 75 may diffuse light emitted from the light guide plate 73 into the second chamber C2. The diffuser 75 may prevent the light emitted from the light guide plate 73 from being partially concentrated, allowing the light to be more uniformly or evenly distributed. The diffuser 75 may be inclined at an inclination angle corresponding to the inclined wall 319. The diffuser 75 may be in contact with the inclined wall 319.

Referring to FIG. 28, light emitted from the light source 86 may be uniformly distributed to an entire surface through the cover 70, enabling surface light emission toward the inclined wall 319 (see FIG. 28). Accordingly, light may be introduced through the entire surface of the inclined wall 319 instead of being locally introduced into the inclined wall 319, and the light may be evenly diffused throughout the second chamber C2 to thereby prevent the formation of a dark region or reduce a dark region in size.

Referring to FIGS. 1 to 28, an aerosol generating device according to an aspect of the present disclosure may include: a body in which a power source is accommodated; a first container detachably coupled to the body and including a wick and a heater, the heater being electrically connected to the power source; and a second container in which a liquid supplied to the wick is stored and detachably coupled to the first container.

According to another aspect of the present disclosure, the wick may include: a first wick part disposed in a first chamber of the first container; and a second wick part protruding from the first wick part to an outside of the first chamber through a liquid inlet formed at the first container and supplied with the liquid from a second chamber of the second container.

According to another aspect of the present disclosure, a periphery of the first wick part may protrude outward in a horizontal direction from a periphery of the second wick part.

According to another aspect of the present disclosure, the periphery of the first wick part may be greater than a periphery of the liquid inlet.

According to another aspect of the present disclosure, an upper portion of the first wick part may be supported by the first container in a vicinity of the liquid inlet, and a lower portion of the first wick part may be supported by a supporter that protrudes from a lower portion of the first container.

According to another aspect of the present disclosure, the aerosol generating device may further include a supporter that supports the first wick part to allow the first wick part to be spaced apart from one surface of the first chamber.

According to another aspect of the present disclosure, the heater may be attached to one surface of the first wick part, which is spaced apart from the one surface of the first chamber, to form a pattern.

According to another aspect of the present disclosure, the aerosol generating device may further include: a first terminal that is fixed to one surface of the first wick part and is provided at each of both ends of the heater; and a second terminal that is configured to come into contact with the first terminal, is exposed to an outside of the first container, and is electrically connected to the power source.

According to another aspect of the present disclosure, a first coupler by which the first container and the body are detachably coupled to each other may be provided.

According to another aspect of the present disclosure, the second container may include: a liquid outlet that is open at a bottom of the second chamber; and an absorbent portion that is fixed to a lower portion of the second container to cover a bottom of the liquid outlet, absorbs a liquid discharged from the liquid outlet, and is configured to come into contact with the wick to transfer a liquid absorbed therein.

According to another aspect of the present disclosure, the second container may include a discharge guide inclined downward from a vicinity of the liquid outlet toward the liquid outlet.

According to another aspect of the present disclosure, the second container may further include a film detachably attached to a lower portion of the absorbent portion before coupling the second container to the first container, so as to prevent liquid penetration.

According to another aspect of the present disclosure, the first container may include: a chamber inlet formed by opening one side of the first container to communicate with the first chamber; and a chamber outlet formed by opening another side of the first chamber to communicate with the first chamber, and an air flow discharge path partitioned from the second chamber and in communication with the chamber outlet.

According to another aspect of the present disclosure, a second coupler by which the second container and the body are detachably coupled to each other may be provided.

Referring to FIGS. 1 to 28, a cartridge according to an aspect of the present disclosure may include: a first container including a first chamber, a wick, and a heater, the wick and the heater being disposed on one side of the first chamber; a second container detachably coupled to the first container and including a second chamber in which a liquid supplied to the wick is stored; a first channel formed on another side of the first chamber and having a first air flow inlet and a first air flow outlet at both ends thereof; and a second channel formed in the second container, partitioned from the second chamber, and having one end in communication with the first air flow outlet.

According to another aspect of the present disclosure, the cartridge may further include a sealer to seal between the first container and the second container in a vicinity of the first air flow outlet when the second container is coupled to the first container.

According to another aspect of the present disclosure, the sealer may surround the vicinity of the first air flow outlet.

According to another aspect of the present disclosure, the first channel may be offset from the wick with respect to a vertical direction.

According to another aspect of the present disclosure, the second container may be coupled on top of the first container. One end of the second channel may be open downward, and the first air flow outlet may be formed on an upper portion of the first chamber.

According to another aspect of the present disclosure, the first air flow inlet may be formed on a lower portion of the first chamber.

According to another aspect of the present disclosure, the first air flow inlet and the first air flow outlet may face each other up and down.

According to another aspect of the present disclosure, the first air flow inlet may be formed on a lateral side of the first chamber.

According to another aspect of the present disclosure, the wick may include: a first wick part disposed on one side of the first chamber; and a second wick part protruding from the first wick part to an outside of the first chamber through the liquid inlet and supplied with the liquid from the second container.

According to another aspect of the present disclosure, the cartridge may further include a supporter to support a lower portion of the first wick part to allow the first wick part to be spaced apart from a lower surface of the first chamber. The heater may be attached to a lower surface of the first wick part to form a pattern.

According to another aspect of the present disclosure, the supporter may be open between the first channel and the heater.

According to another aspect of the present disclosure, the cartridge may further include a mouthpiece covering one side of the second container and having a second air flow outlet in communication with another end of the second channel.

According to another aspect of the present disclosure, when air at an outside of the first container is introduced into the first channel through the first air flow inlet and then sequentially passes through the first air flow outlet and the second channel, air on one side of the first chamber may be introduced into the first channel disposed on another side of the first chamber.

A cartridge according to an aspect of the present disclosure may include: a first container including a first chamber, a wick, and a heater, the wick and the heater being disposed at the first chamber; a second container detachably coupled to the first container and including a second chamber in which a liquid supplied to the wick is stored; a first channel formed in the first chamber, having a first air flow inlet and a first air flow outlet at both ends thereof, and passing through the wick; and a second channel formed in the second container, partitioned from the second chamber, and having one end in communication with the first air flow outlet.

An aerosol generating device according to an aspect of the present disclosure may include: a body to which the first container is detachably coupled; and a second air flow inlet that is open at the body and is configured to communicate with the first air flow inlet.

Referring to FIGS. 1 to 28, a cartridge according to an aspect of the present disclosure may include: a first container including a wick and a heater, the first container having a liquid inlet through which the wick is exposed; a second container detachably coupled to the first container and configured to supply a liquid to the wick through the liquid inlet; and a sealer to seal the first container and the second container in a vicinity of the liquid inlet.

According to another aspect of the present disclosure, the sealer may include a sealing wall that surrounds the vicinity of the liquid inlet and protrudes from the first container toward the second container.

According to another aspect of the present disclosure, the sealing wall may include: a first sealing wall; and a second sealing wall formed outside the first sealing wall.

According to another aspect of the present disclosure, the second sealing wall may protrude further than the first sealing wall, and the second container may include a recess portion into which the second sealing wall is inserted to be in close contact therewith.

According to another aspect of the present disclosure, the second container may include: an absorbent portion that covers a bottom of a liquid outlet through which the stored liquid is discharged, absorbs a liquid discharged from the liquid outlet, and is configured to come into contact with the wick to transfer a liquid absorbed therein; and a bracket that protrudes downward from a vicinity of the liquid outlet, surrounds a periphery of the absorbent portion, and fixes the absorbent portion.

According to another aspect of the present disclosure, the recess portion may surround a vicinity of the bracket, and the bracket may be in close contact with the first sealing wall.

According to another aspect of the present disclosure, the wick may include: a first wick part disposed in the first container; and a second wick part protruding from the first wick part to an outside of the first container through the liquid inlet and supplied with the liquid from the second container.

According to another aspect of the present disclosure, the sealer may include a first chamber sealing portion that surrounds a periphery of the second wick part and seals between a periphery of the liquid inlet and the periphery of the second wick part.

According to another aspect of the present disclosure, a periphery of the first wick part may protrude outward in a horizontal direction from the periphery of the second wick part.

According to another aspect of the present disclosure, the periphery of the first wick part may be greater than the periphery of the liquid inlet.

According to another aspect of the present disclosure, the sealer may include a second chamber sealing portion that surrounds a vicinity of the liquid inlet, protrudes downward, and seals between un upper surface of the first wick part and one wall on which the liquid inlet is formed.

According to another aspect of the present disclosure, the first container may include a supporter to support a lower portion of the first wick part.

An aerosol generating device according to an aspect of the present disclosure may include a body to which the first container is detachably coupled and in which a power source electrically connected to the heater is accommodated.

Referring to FIGS. 1 to 28, an aerosol generating device according to an aspect of the present disclosure may include: a body; a first container configured to be coupled to the body and including a wick and a heater; a second container configured to be detachably coupled to the first container; and defining a chamber configured to store a liquid to be supplied to the wick and a light source installed at the body and configured to provide light toward the chamber. The second container may include an inclined wall defining an obliquely angled portion of the chamber and configured to allow transmission of light therethrough from the light source into the chamber.

According to another aspect of the present disclosure, the light source may be disposed on an inclined surface to face the inclined wall.

According to another aspect of the present disclosure, the aerosol generating device may further include a reflector configured to reflect light from the light source that passes through the chamber, back toward the chamber.

According to another aspect of the present disclosure, the reflector may be positioned at a wall of the chamber, which is adjacent to a corner opposite the inclined wall with respect to the chamber.

According to another aspect of the present disclosure, the aerosol generating device may further include a cover comprising an inclined surface and configured to cover the light source and allow transmission of light therethrough from the light source toward the inclined wall of the chamber.

According to another aspect of the present disclosure, the cover may further include a light guide plate configured to evenly distribute the light from the light source.

According to another aspect of the present disclosure, the cover may further include a diffuser that covers the light guide plate to face the inclined wall, and is configured to evenly diffuse the light from the light guide plate.

According to another aspect of the present disclosure, the inclined wall may connects a lower wall and a lateral wall of the chamber, and the light source may be disposed under the inclined wall to be adjacent to the second container.

According to another aspect of the present disclosure, the light source may be laterally adjacent to the first container, and the second container may be configured to be coupled on top of the first container.

According to another aspect of the present disclosure, the aerosol generating device may further include a reflector configured to reflect light from the light source that passes through the chamber back toward the chamber. The reflector may be positioned at at least one of a second lateral wall or an upper wall of the chamber, which are opposite the inclined wall with respect to the chamber.

According to another aspect of the present disclosure, the first container may comprise an air flow outlet allowing airflow from an interior space where the wick is disposed, and the second container may be formed to define an air flow discharge path partitioned from the chamber and in communication with the air flow outlet. The inclined wall may be inclined in a direction toward the air flow discharge path at a position laterally opposite the air flow discharge path with respect to the chamber.

According to another aspect of the present disclosure, the first container may comprise a first air flow outlet allowing airflow from an interior space where the wick is disposed, and the second container may be formed to define an air flow discharge path partitioned from the chamber and in communication with the first air flow outlet. The aerosol generating device may further include an upper case configured to be detachably coupled to the body to surround the second container, allow transmission of light therethrough at a portion of the upper case covering the chamber, and comprise a mouthpiece having an air flow outlet in communication with the air flow discharge path.

An aerosol generating device according to another aspect of the present disclosure may include: a body; a first container configured to be coupled to the body and including a wick and a heater; a second container configured to be detachably coupled to the first container and defining a chamber configured to store a liquid to be supplied to the wick, wherein at least a portion of the second container is configured to allow light to pass therethrough into the chamber; a light source installed at the body and configured to provide light toward the chamber; and a reflector configured to reflect light from the light source that passes through the chamber, back toward the chamber.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device comprising:
a body;
a first container configured to be coupled to the body and comprising a wick and a heater;
a second container configured to be detachably coupled to the first container and defining a chamber configured to store a liquid to be supplied to the wick; and
a light source installed at the body and configured to provide light toward the chamber,
wherein the second container comprises an inclined wall defining an obliquely angled portion of the chamber and configured to allow transmission of light therethrough from the light source into the chamber.

2. The aerosol generating device of claim 1, wherein the light source is disposed on an inclined surface to face the inclined wall.

3. The aerosol generating device of claim 2, further comprising a reflector configured to reflect light from the light source that passes through the chamber back toward the chamber.

4. The aerosol generating device of claim 3, wherein the reflector is positioned at a wall of the chamber that is adjacent to a corner opposite the inclined wall with respect to the chamber.

5. The aerosol generating device of claim 1, further comprising a cover comprising an inclined surface and configured to cover the light source and allow transmission of light therethrough from the light source toward the inclined wall of the chamber.

6. The aerosol generating device of claim 5, wherein the cover further comprises a light guide plate configured to evenly distribute the light from the light source.

7. The aerosol generating device of claim 6, wherein the cover further comprises a diffuser that covers the light guide plate to face the inclined wall, and is configured to evenly diffuse the light from the light guide plate.

8. The aerosol generating device of claim 1, wherein the inclined wall connects a lower wall and a lateral wall of the chamber, and
wherein the light source is disposed under the inclined wall to be adjacent to the second container.

9. The aerosol generating device of claim 8, wherein the light source is laterally adjacent to the first container, and
wherein the second container is configured to be coupled on top of the first container.

10. The aerosol generating device of claim 8, further comprising a reflector configured to reflect light from the light source that passes through the chamber back toward the chamber,
wherein the reflector is positioned at at least one of a second lateral wall or an upper wall of the chamber which are opposite the inclined wall with respect to the chamber.

11. The aerosol generating device of claim 1, wherein the first container comprises an air flow outlet allowing airflow from an interior space where the wick is disposed,
wherein the second container is formed to define an air flow discharge path partitioned from the chamber and in communication with the air flow outlet, and
wherein the inclined wall is inclined in a direction toward the air flow discharge path at a position laterally opposite the air flow discharge path with respect to the chamber.

12. The aerosol generating device of claim 1, wherein the first container comprises a first air flow outlet allowing airflow from an interior space where the wick is disposed,
wherein the second container is formed to define an air flow discharge path partitioned from the chamber and in communication with the first air flow outlet, and
wherein the aerosol generating device further comprises an upper case configured to be detachably coupled to the body to surround the second container allow transmission of light therethrough at a portion of the upper case covering the chamber, and comprises a mouthpiece having an air flow outlet in communication with the air flow discharge path.

13. An aerosol generating device comprising:
a body;
a first container configured to be coupled to the body and comprising a wick and a heater,
a second container configured to be detachably coupled to the first container and defining a chamber configured to store a liquid to be supplied to the wick, wherein at least a portion of the second container is configured to allow light to pass therethrough into the chamber,
a light source installed at the body and configured to provide light toward the chamber, and
a reflector configured to reflect light from the light source that passes through the chamber back toward the chamber.
